(19) United States
(12) Patent Application Publication
(10) Pub. No.: US 2005/0198291 A1
(43) Pub. Date: Sep. 8, 2005

(54) Remote access system and method

(76) Inventors: Anthony Hull, Littlemore (GB); Chris A. Brown, Bicester (GB); Steffan J. Corley, Cowley (GB); Victor Poznanski, Sandford-on-Thames (GB); Claire Green, Cumnor (GB); Michio Wise, Buckinghamshire (GB); Philip Edmonds, Oxford (GB); Katsuo Doi, Sakurai-shi (JP); Ryoichi Sato, Oxford (GB)

Correspondence Address: MARK D. SARALINO (GENERAL);RENNER, OTTO, BOISELLE & SKLAR, LLP, 1621 EUCLID AVENUE, NINETEENTH FLOOR, CLEVELAND, OH, 44115-2191, US

(21) Appl. No.: 10/872,038

(22) Filed: Jun. 18, 2004

(30) Foreign Application Priority Data
Jun. 20, 2003 (GB) 0314410.2

(51) Int. Cl. G06F 15/173; H04L 9/32; G06F 12/14

(52) U.S. Cl. 709/225; 713/201

(57) ABSTRACT

A method is provided of retrieving one or more data items stored in a protected area of a remote server for transferral to a local device. A trusted connection is formed between an information device and the protected area of the remote server. The information device and the trusted connection are employed to select a first group of one or more data items stored in the protected area of the remote server. The first group of data items are transferred from the protected area to a holding area outside the protected area of the remote server. A retrieval connection is formed between the local device and the holding area. A second group of one or more data items is determined from the first group of data items transferred to the holding area. The second group of data items is transferred from the holding area to the local device over the retrieval connection.

This Nonprovisional application claims priority under 35 U.S.C. §119(a) on Patent Application No. 0314410.2 filed in Great Britain on Jun. 12, 2003, the entire contents of which are hereby incorporated by reference.

### BACKGROUND OF THE INVENTION

1. Field of the Invention

The present invention relates to a remote access system and method, and particularly to a remote access system and method for transferring data items between a remote server and a local device, especially where the security of the remote server is an issue.

2. Description of the Related Art

It is increasingly common for workers to require access to corporate documents and email even when away from the office, and a variety of products and systems have been developed to suit the needs of such mobile workers. Most popular are Virtual Private Networks (VPNs) and VPN solutions are now available for both computers, for example desktop and laptop Personal Computers (PCs), and mobile devices, for example Personal Digital Assistants (PDAs) and mobile phones.

However, while a VPN allows interaction with private corporate information on a device's screen, it does not always give convenient access to the surrounding peripherals. For example, a mobile worker cannot use an available (public) printer unless they physically attach it to their mobile device and install drivers. Similarly, scanners, monitors, projectors and other peripherals cannot be used in an ad hoc and wireless way so as to interact securely with private corporate information. This is particularly so for mobile workers for whom it is not practical to carry a laptop since, although mobile devices are being developed to support VPNs, these devices lack rendering capabilities, drivers and the physical connectivity to allow connection to local peripherals.

Peripherals such as those mentioned are becoming publicly available. For example, convenience stores such as Lawson's and Seven-Eleven in Japan already have printers behind the counter, currently used mainly for photo printing.

Our co-pending United Kingdom application no. 0309045.3 describes a system allowing a corporate server to stream a rendered document through a mobile device to a local printer. However, this system requires much, if not all, of the rendered document to be transferred over potentially costly and slow mobile networks. It also requires the mobile device to have capabilities that are not yet standard.

FIG. 1 of the accompanying drawings is a block diagram illustrating a remote access system disclosed in U.S. Pat. No. 6,144,997 (“System and method for accessing and distributing electronic documents”), U.S. Pat. No. 6,397,621 (“Secure token-based document server”), U.S. Pat. No. 6,430,601 (“Mobile Document Paging Service”) and U.S. Pat. No. 6,487,189 (“Mobile E-mail Document Transaction Service”). The system, referred to herein as the Satchel system, comprises a mobile device 2 in wireless communication with a document server 4 and an Internet-enabled appliance 6. The system allows the wireless mobile device 2 to store a document token, for example a URL (Uniform Resource Locator), specifying a document to be retrieved from the document server 4, and to pass on the document token wirelessly to the Internet-enabled appliance 6 in order that the appliance 6 may retrieve the document specified by the document token from the document server 4. The system allows the distribution of documents from one person to another by transmission of the document token rather than the document itself.

FIG. 2 of the accompanying drawings is a block diagram illustrating the PrintMe system (see www.printme.com for details). The system comprises a PrintMe Service 10 located within and accessible through the World Wide Web 8, a Personal Computer 16 located within a private space 12, for example a Local Area Network (LAN), protected by a barrier 14 such as a firewall, and a PrintMe Printer 18.

The PrintMe system operates as follows. A mobile user who wishes to print a document located on their Personal Computer 16 uploads that document in advance from the Personal Computer 16 to the PrintMe Service 10, usually relying on the PrintMe service to render the document before printing. The user can specify which one of a number of PrintMe printers 18 is to print the document at the time of uploading that document to the PrintMe Service 10, so that every PrintMe printer 18 requires a unique identifier. It is also possible that a code is generated by the PrintMe Service 10 associated with the document the user has uploaded; the user is then able to enter the code directly into the chosen printer in order to retrieve and print the document at that printer.

U.S. Pat. No. 2002/0004404 describes a system in which the user sends a message to a display or printer, via a mobile phone network. This message contains the URL of some content that the user wishes the appliance to display or print. The appliance then retrieves this content and renders it.

U.S. Pat. No. 2003/0038979 describes a system that automatically prints an attachment to an email, depending on the type of the attachment. This method also has inherent problems with security and there are also no guarantees of delivery or delivery time. A similar system is described in JP 5-002541, while JP 5-143253 adds a security mechanism to ensure that the email is not printed when the user is not located next to the printer, and U.S. Pat. No. 2001/0017712 proposes an alternative security arrangement. Internet document RFC 1528 (http://www.faqs.org/rfcs/rfc1528.html), dating from October 1993, also proposes sending information to be printed via email.

It is important in many commercial and academic environments that the document to be accessed and printed by the mobile user is subject to strict security measures that prevent unauthorised access to and/or manipulation of the document. There are several ways in which the security measures adopted in the prior art systems can be improved. There are also other aspects relating to the implementation of a remote access system and the means of accessing and transferring the document that should be addressed.

### SUMMARY OF THE INVENTION

An embodiment of a first aspect of the present invention provides a method of retrieving one or more data items stored in a protected area of a remote server for transferral to a local device. A trusted connection is formed between an information device and the protected area of the remote server. The information device and the trusted connection are employed to select a first group of one or more data items stored in the protected area of the remote server. The first group of data items is transferred from the protected area to a holding area outside the protected area of the remote server. A retrieval connection is formed between the local device and the holding area. A second group of one or more data items is determined from the first group of data items transferred to the holding area. The second group of data items is transferred from the holding area to the local device over the retrieval connection.

The retrieval connection may be formed in dependence upon a location identifier representing the location of the holding area. The location identifier itself may contain sufficient information to identify the location of the holding area, or the method may further comprise the step of looking up the location of the holding area in dependence upon the location identifier. In the case where the full location is looked up in dependence upon the location identifier, the representation of the location identifier is preferably smaller than the representation of the full location. For example, the location identifier may comprise a Uniform Resource Locator (URL) in which the location is represented by a string of characters, which may be a long string. The location identifier itself may be much shorter, with a further look-up step, allowing ease of entry of the location identifier into the local device. The location identifier may be determined by the remote server, for example when the holding server is chosen, and communicated to the local device for use in forming the retrieval connection. On the other hand, the location identifier may be determined by the local appliance and communicated to the remote server for use in transferring the first group of data items to the holding area. In the latter case, the local appliance may, for example, have a particular associated holding server that it specifies for such data item transfers. The second group of data items may be determined in dependence upon a group identifier identifying the first group of data items transferred to the holding area.

Access from the local device to the first group of data items transferred to the holding area may be gained in dependence upon an access identifier associated with the first group of data items. The access identifier may comprise the group identifier. The access identifier may also comprise the location identifier, so that the access identifier could represent both the location of the holding area and the data items transferred to the holding area. The access identifier may be communicated to the local device from the information device. The access identifier may be generated at the remote server and communicated to the information device over the trusted connection. The access identifier may also be stored on the remote server for subsequent retrieval by the information device. The access identifier may also be generated at the information device. The access identifier may be communicated to the local device by manually entering the access identifier into the local device. On the other hand, the method may further comprise the steps of making a connection between the information device and the local device, and communicating the access identifier from the information device to the local device over that connection. The connection between the information device and the local device may be a wireless connection, for example over a Local Area Network, a Bluetooth connection or an infrared connection. The connection between the information device and the local device may also be a physical connection, and the method may further comprise the step of placing the information device in a cradle connected to the local device to form the physical connection. The connection between the information device and the local device may be a secure connection.

The second group of data items may be determined to be the same as the first group of data items. For example, this may be determined in advance so that it is not essential that there is a separate step of selecting the second group following the selection of the first group. In this case, all data items in the first group are transferred to the local device upon a suitable request.

The method may further comprise the step of employing the local device to select and determine the data items in the second group of data items. The method may comprise the steps of presenting a list of data items in the first group at the local device and selecting the second group from the list for transfer from the holding area to the local device. The method may further comprise the steps of retrieving from the holding area information concerning one or more of the data items in the first group and presenting that information at the local device to facilitate the selection the second group of data items. The information may be, for example, the name of the data item, its date of creation, its creator, its security level or its size. If the transfer of a data item is to be subject to a charge, charging information may also be displayed.

The retrieval connection may be a high-speed connection, and may be an Internet connection. The local device may use generic Internet browsing capabilities when accessing and/or selecting and/or retrieving data items in the holding area. The retrieval connection may be a secure connection. The trusted connection may be a secure connection. The trusted connection between the information device and the remote server may be over a Virtual Private Network. The trusted connection may be granted to the information device following verification by the remote server that the information device is authorised for access to the protected area.

The information device may connect to the remote server using a direct dial connection, and may connect to the remote server using a trusted operator. The protected area of the remote server may be protected by a firewall. Information may be transmitted over the trusted connection between the information device and the remote server using the Secure Sockets Layer protocol. The trusted connection may be a wireless connection, for example over a Local Area Network or a mobile telecommunications connection.

The method may further comprise the step of processing a data item before transferring it to the local device. The processing that is performed may be dependent upon the type of the local device, and may be dependent upon the location of the local device. The processing may take place at the remote server or at the holding server, or both.

The method may further comprise the step of storing the first group of data items in a hidden area within the holding area. The method may further comprise the step of storing the group of data items in a secure area of the holding area accessible only with appropriate authentication information. The secure area may be password protected and the authentication information may comprise a password. The authentication information may be included in the access identifier.

The method may further comprise the steps of encrypting a data item before transferring it to the holding area, and decrypting the data item after receipt at the local device. The access identifier may further comprise decryption information necessary to perform decryption of the data item. The encryption and decryption may use a symmetric key cryptography algorithm.

The method may further comprise the step of the revoking the access identifier after a predetermined number of uses. A use in this context may be an access to the holding area using that identifier, or simply the act of entering the access identifier into the local device. For example, the access identifier may be revoked after one use. The method may further comprise the step of generating a new access identifier, for example after the previous one has been revoked. The new access identifier may then be communicated to the local device, for example from the remote server to the local device via the information device, for use in accessing the data items in the holding area.

The method may further comprise the step of revoking the access identifier after a predetermined length of time, for example a predetermined length of time following generation of the identifier. This may happen even if the access identifier has not been used. The method may further comprise the step of revoking the access identifier after all the data items associated with the access identifier have been retrieved from the holding area. A data item may be deleted from the holding area after it has been retrieved a predetermined number of times, for example once. One or more data items associated with the access identifier may be deleted if the access identifier is revoked.

The method may further comprising the step of deleting a data item from the public space after a predetermined length of time.

The local device may comprise an output device. Where the local device comprises a printer, the method may further comprise the step of printing part or all of at least one of the data items transferred to the local device on the printer. Where the local device comprises a display, the method may further comprise the step of displaying part or all of at least one of the data items transferred to the local device on the display. If the output of a data item on the local device is to be subject to a charge, charging information may be presented to the user before the data item is selected for transfer from the holding area and/or before the data item is output at the local device. At least one of the data items may be an email item. At least one of the data items may be a document. Other examples of output devices are projectors and electronic whiteboards.

The information device may form part of the local device. Therefore it is not necessary for a dedicated information device to be used. The functionality of the information device described above may be included in the local device itself.

The information device may be a mobile information device, for example a Personal Digital Assistant, a mobile phone, a cordless phone or a laptop computer. The information device may also be a Digital Television, a telephone or a Personal Computer.

The information device may first require to be authenticated, for example by requesting the Subscriber Identity Module number or other operator identifier from the information device, either before access is granted to the secure area of the remote server or to the data items transferred to the holding area, or both. The user may also require to be authenticated, for example by having to enter a PIN or password at the information device. The authentication information produced may be included as part of the access identifier, so that if the authentication fails then access from the local device to the first group of data items transferred to the holding area is not granted. This is useful for preventing a rogue information device using a stolen location and/or group identifier to access the holding area, or a genuine information device with a genuine access identifier stored thereon being operated by a rogue user.

The local device may also be a mobile information device, for example a Personal Digital Assistant, a mobile phone or a laptop computer, or may be a Digital Television or a Personal Computer.

The holding area may be located on the same remote server as the protected area, or on a separate holding server. In any case, the remote server may be in proximity to the holding area. The holding area may be located on a public server accessible by any public device. This allows for ease of access by a greater variety of local devices. The local device may be a public appliance accessible by the general public, or may be in a private home or office. It may be that a single superuser has privileged access to the contents of both the protected area and the holding area. For example, both areas may be under control of a single company.

The information device may be in proximity to the local device, and indeed the method may further comprise the step of verifying that the information device is in proximity to the local device by comparing the location of the information device with the location of the local device. One or both of the locations may be provided by the Global Positioning System. If the location of the local device is fixed, the location could be determined at the time of installing the local device, for example, rather than at the time of verification. Where the information device is in wireless communication with a plurality of base stations, the location of the information device may be provided by determining its position relative to the base stations. Another method for establishing proximity is to determine whether the information device and local device can establish a connection over a local wireless network (IrDA, Bluetooth, wireless LAN).

The method may further comprise the step of transferring one or more data items received at the local device to a separate device. Therefore the local device may simply be used as an access point for high-speed retrieval of data items to the separate device, with the retrieved data items not being used as such by the local device. The separate device may even be the information device, so that data items retrieved from the remote server end up on the information device that requested them.

The item or items in the first group of data items may be pushed from the protected area into the holding area, and the communication link between the protected area and the holding area may be a one-way communication link. These measures increase the security of the protected area and help to prevent unauthorised intrusion into the protected area making use of the communication link set up between the protected area and the holding area, which holding area may be a public access area. The communication link between the protected area and the holding area may further be a secure communication link.

An embodiment of a second aspect of the present invention provides a remote retrieval system. A remote server is provided with a protected area for storing data items. A holding area is provided outside the protected area of the remote server. An information device is in communication with the protected area of the remote server over a trusted connection. The information device and the trusted connection are employed to select a first group of one or more data items stored in the protected area of the remote server. The first group of data items is transferred from the protected area to the holding area outside the protected area of the remote server. A local device is in communication with the holding area over a retrieval connection. A second group of one or more data items is determined from the first group of data items transferred to the holding area. The second group is transferred from the holding area to the local device over the retrieval connection.

An embodiment of a third aspect of the present invention provides a method of employing an information device to retrieve one or more data items stored in a protected area of a remote server for transferral to a local device. A trusted connection is formed between the information device and the protected area of the remote server.

The information device and the trusted connection are employed to select one or more data items stored in the protected area of the remote server. The selected data items are caused to be transferred from the protected area to a holding area outside the protected area of the remote server for subsequent retrieval by the local device.

An embodiment of a fourth aspect of the present invention provides an information device for retrieving one or more data items stored in a protected area of a remote server for transferral to a local device. A connection portion forms a trusted connection between the information device and the protected area of the remote server. A selection portion employs the information device and the trusted connection to select one or more data items stored in the protected area of the remote server. A transferral portion causes the selected data items to be transferred from the protected area to a holding area outside the protected area of the remote server for subsequent retrieval by the local device.

An embodiment of a fifth aspect of the present invention provides an operating program which, when loaded into an information device, causes the device to become one according to an embodiment of the fourth aspect of the present invention.

An embodiment of a sixth aspect of the present invention provides an operating program which, when run on an information device, causes the device to carry out a method according to an embodiment of the third aspect of the present invention.

The operating program may be carried on a carrier medium, which may be a transmission medium or a storage medium.

An embodiment of a seventh aspect of the present invention provides a method of transferring one or more data items from a local device to a protected area of a remote server. A group of one or more data items stored on the local device is selected. A transferral connection is formed between the local device and a holding area outside the protected area of the remote server. The group of data items is transferred from the local device to the holding area over the transferral connection. A trusted connection is formed between an information device and the protected area of the remote server. The information device and the trusted connection are employed to transfer one or more data items from the group of data items in the holding area into the protected area of the remote server.

One or more data items may be pulled by the remote server into the protected area from the holding area. The local device may comprise an input device, such as a scanner or a photocopier.

An embodiment of an eighth aspect of the present invention provides a remote transferral system. A remote server is provided having a protected area for storing data items. A holding area is provided outside the protected area of the remote server. A local device is in communication with the holding area over a transferral connection. A group of one or more data items on the local device is transferred to the holding area over the transferral connection. An information device is in communication with the protected area of the remote server over a trusted connection. The information device and the trusted connection are employed to transfer one or more data items from the group of data items in the holding area into the protected area of the remote server.

### BRIEF DESCRIPTION OF THE DRAWINGS

FIG. 1, discussed hereinbefore, is a block diagram illustrating a prior art remote access system;

FIG. 2, also discussed hereinbefore, is a block diagram illustrating another prior art remote access system;

FIG. 3 is a block diagram illustrating a remote retrieval system according to a first embodiment of the present invention;

FIG. 4 is a flowchart for use in explaining the operation of the remote retrieval system of FIG. 3;

FIG. 5 is a block diagram illustrating a remote transferral system according to a second embodiment of the present invention; and

FIG. 6 is a flowchart for use in explaining the operation of the remote transferral system of FIG. 5.

### DETAILED DESCRIPTION OF THE PREFERRED EMBODIMENTS

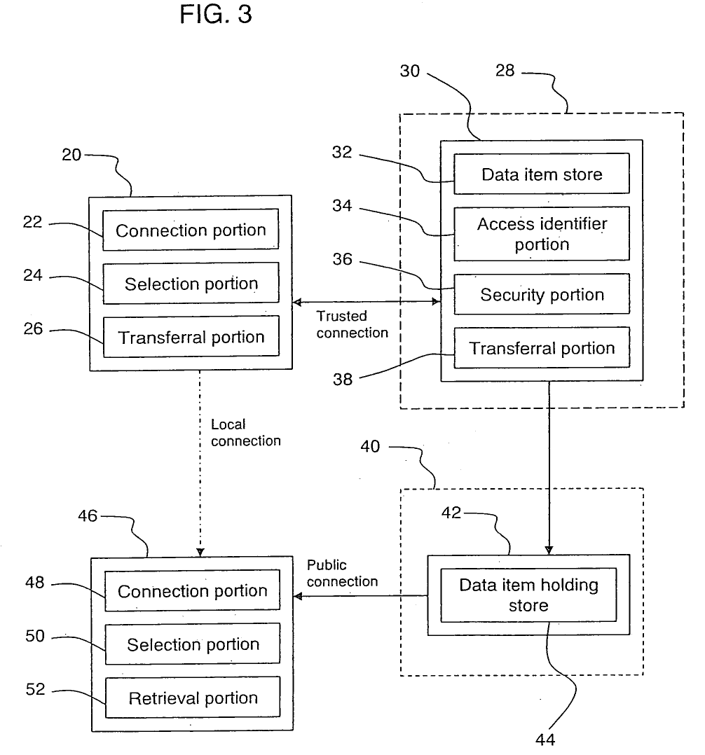

FIG. 3 is a block diagram illustrating a remote retrieval system according to a first embodiment of the present invention. The remote retrieval system comprises an information device 20, a remote server 28, a holding server 40 and a local device 46. The information device 20 comprises a connection portion 22, a selection portion 24 and a transferral portion 26. The remote server 28 comprises a protected area 30 having a data item store 32, an access identifier portion 34, a security portion 36 and a transferral portion 38. The holding server 40 comprises a holding area 42 having a data item holding store 44. The local device 46 comprises a connection portion 48, a selection portion 50 and a retrieval portion 52.

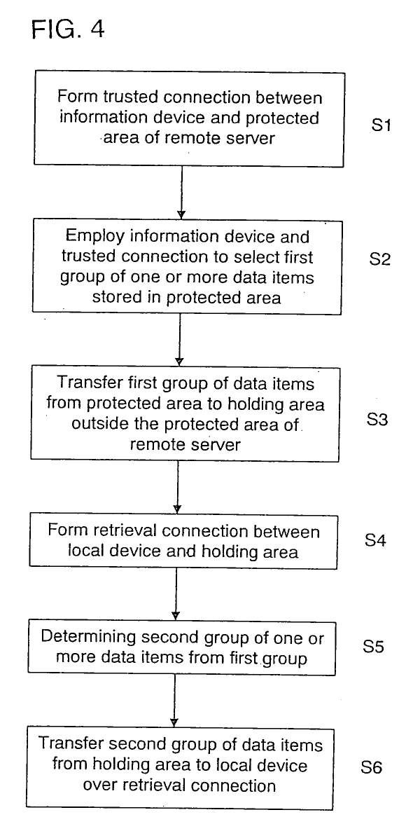

A method of retrieving one or more data items stored in the protected area 30 of the remote server 28, for transferral to the local device 46, will now be described with reference to the flowchart shown in FIG. 4.

The connection portion 22 of the information device 20 attempts to initiate a connection to the remote server 28. The security portion 36 verifies the authenticity and trustworthiness of the information device 20, and if satisfied then a trusted connection is formed between the information device 20 and the protected area 30 of the remote server 28 (step S1). The user of the information device 20 then employs the information device 20 and the trusted connection to select a first group of one or more data items stored in the data item store 32 of the protected area 30 of the remote server 28 (step S2). This selection process in this embodiment is controlled by the selection portion 24 of the information device 20.

On the request of the user of the information device 20, the transferral portion 26 of the information device 20 generates a request to the remote server 28 to transfer the first group of data items from the protected area 30 to the data item holding store 44 within the holding area 42 outside the protected area 30 of the remote server 28 (step S3). This request is processed by the transferral portion 38 of the remote server 28. The location of the holding area 42 is represented by a location identifier and the first group of data items transferred to the holding area 42 is identified by a group identifier. In this embodiment, a single access identifier comprising the location and group identifiers is issued by the access identifier portion 34 of the remote server 28 and communicated to the information device 20. The access identifier enables the data items to be retrieved from the holding area 42 by the local device. In this embodiment, the access identifier that is communicated to the information device 20 is simply read off by the user and entered manually into the local device 46.

A retrieval connection is formed by the connection portion 48 of the local device 46 between the holding area 42 and the local device 46 (step S4) and a second group of one or more data items can be selected from the first group of data items being held in the holding area (step S5). This is achieved by presenting to the user at the local device a list of available documents, which the user can select, and this is controlled by the selection portion 50 of the local device 46. Having determined the second group of data items, those data items are transferred from the holding area 42 to the local device 46 over the retrieval connection (step S6) under the control of the retrieval portion 52 of the local device 46.

This embodiment of the present invention allows the information device 20 (e.g. a mobile device) to arrange for the local device 46 (e.g. a local peripheral) to have limited and temporary access to the data items (e.g. corporate documents and emails) over the retrieval connection (e.g. the Internet), without compromising current security arrangements for the protected area 30 of the remote server 28 (e.g. a corporate Local Area Network (LAN)). The local peripheral can act as a secure, temporary extension to the user's office, without the cost and speed penalties of transferring the document over the mobile networks. An embodiment of the present invention will work on current generation mobile devices. The local device may be a printer, allowing the mobile worker to print corporate documents and email whilst on the move.

An embodiment of the present invention allows the user of a mobile device (information device) to output, to a public device (local device), documents that are stored on a protected network. The user has a secure connection into a private and protected space, such as a corporate LAN. This private space is protected from intrusion by some mechanism. The mechanism may be a firewall, in which case access is normally achieved via a Virtual Private Network, but may also be a password-protected area in a data centre. The holding area 42 may be on a public space such as a web server to which any Internet appliance can connect and, given appropriate authentication, retrieve information from. In the above embodiment, information is pushed from the protected area 30 out to the holding area 42, but there is no access from the holding area 42 into the protected area 30. This greatly enhances the security of the protected area 30.

In step S2 above, the user can use the mobile device to browse or search the protected area and select documents for transfer. If necessary, the documents can be transformed into a format suitable for printing (e.g. Adobe® PDF format) and copied from the protected area 30 to the holding area 42. The processing may take place at the holding server 40. The data item holding store 44 may be in a hidden or password-protected area of the holding server 40, and the documents can be encrypted before leaving the protected area 30.

For a high level of security it is preferable that the access identifier is a one-time access identifier, so that, for example, once the access identifier has been entered into local device 46 it is immediately revoked and cannot be used again. The access identifier could also be revoked only after the documents have been retrieved, although this is less secure. Once the local device 46 indicates that it has finished retrieving the documents, they can be deleted from the holding area 42.

One scenario in which an embodiment of the present invention may operate is set out as follows. The information device 20 may be a mobile phone that connects via a Virtual Private Network to the remote server 28 on the user's Local Area Network (LAN). The server 28 may deliver web pages to the mobile phone, allowing the user to interact through a browser on the device. The web pages present browse and search functionality for the user's documents and emails on the LAN. The user selects one or more documents for printing and then requests them to be printed (e.g. by pressing a “print” button appearing on the screen of the device). At this point, the documents can be transformed into PDF and uploaded to the holding server 40 (for example in the company's “demilitarized zone”). At the same time, the one-time access identifier is generated for these documents in the holding server 40. This access identifier is displayed on the user's mobile device. The user then walks up to a public printer (the local device 46) with attached web browser. They enter the address of the company's public server (the holding server 40) into this browser, and an authentication page is displayed. They enter their one-time access identifier (and possibly a personal identifier) into this page and are now shown their list of documents, together with pricing information; their one-time identifier is immediately marked as invalid and they will not be able to log in again with this identifier. They may select one or more documents for printing and, after any necessary payment, the documents will be printed on the public printer (the local device 46). Finally, once the documents have been transferred to the printer, they are deleted from the document repository in the holding server 40.

The documents might be differently formatted depending on the type of local device; for example, if the local device is a computer it might be offered the documents in their original format (Microsoft® Word, for example), whereas a printer might be offered the documents in a printer-compatible format (e.g. PDF). Additional services might be offered for a particular local device. For example, a computer might be allowed to download a document, edit it and then upload it again to the holding server, from where it would be pulled back in to the protected area. Similarly, the holding server could automatically detect that the public appliance is in a particular country and offer to perform an automatic translation of the document into the local language. These additional formatting and other services could be offered by the remote server or the holding server.

The information device 20 may be any suitable device, such as a Personal Digital Assistant (PDA), a laptop, a desktop computer in another company or a web-enabled TV. The access identifier could be n-time instead of one-time, so that the identifier is revoked after n uses, or some other regime may be used. The information device can access the LAN via a direct dial connection or a trusted operator, without the need for a VPN. The information device can access the LAN via SSL. The local device can be any public or Internet appliance such as an Internet-enabled photocopier, stand-alone monitor or a computer in an Internet cafe. The local device may be in an office (e.g. photocopier, someone else's computer), or may be someone else's private device (e.g. computer, another mobile device, Internet-enabled TV, home server or gateway). The location identifier and access identifier can be transmitted to the local device using a wireless networking technology such as infrared, Bluetoooth or wireless LAN, or using a wired link (e.g. the information device may be placed in a cradle or otherwise physically attached to the local device).

Another scenario in which an embodiment of the present invention may operate is set out as follows. A user visits a friend's house, and using his mobile phone, he browses his photograph collection, stored on his home PC or home server, and selects some photographs to show his friend. The photos are uploaded to a holding server (e.g. at the Internet Service Provider) and the access identifier is displayed on his phone. The user then uses his friend's web-enabled TV to browse to the holding server, log in (using the access identifier) and show his friend the photographs on his friend's own TV.

Documents may be deleted from the holding server and the access identifier revoked after a preset time, even if the documents have not been accessed. The holding server may require the entry of some user-specific identifier (e.g. a PIN) as well as the access identifier in order to authenticate the user. The holding server and/or the remote server may require the SIM number or some other operator identification method to authenticate the mobile device. For example, the remote server may use the SIM number to authenticate the mobile device and pass an authentication code back to the information device. Or the operator may also authenticate the information device and pass an authentication code back to the information device. The information device can then pass such an authentication code on to the local device. The authentication code may be included as part of the access identifier to authenticate the information device with the holding server so as to allow access to the documents specified in the access identifier. The holding server may, for example, have been previously provided with this authentication code or may contact the operator to check the authentication code.

The data items of the first group may comprise data items transferred to the holding server by separate requests. For example, a user may use the information device to select and transfer a first data item to the holding server, and subsequently in a separate request to select and transfer a second, different, data item to the holding server. The first and second data items in the holding server can be treated as being part of the first group associated with a single access identifier, or as two different first groups associated with different respective access identifiers. It is possible that a particular user is allocated a single access identifier at any one time, and this access identifier enables the user to access all of the data items on the holding server transferred by him. The group identifier part of the access identifier may be held on the holding server, linked to a particular user, rather than being transferred to the information device and on to the local device. When the user wishes to access the data items he would enter authentication information at the local device (either manually or by electronic transfer) to identify the user, and this authentication information would then be used to correlate with the correct group identifier on the holding server and to access the appropriate data items based on that group identifier. The group identifier could be revoked using the same scheme as described elsewhere in this specification in respect of the access identifier, with a “use” of the group identifier being regarded equivalently. The group identifier may instead be linked to a particular information device, or a particular remote server, and activated given appropriate authentication information to gain access to all data items in that group. The group identifier may be linked to more than one user and/or device and/or server. Other such variations would be apparent to a person skilled in the art.

The documents may be encrypted before being passed to the holding server. The access identifier may include the necessary decryption information. In the case where the user enters the information into the local (Internet) device by hand, there may be a lookup service to allow the user to enter a short string or number into the Internet device, rather than having to enter the entire location of the holding server. Instead of entering the information by hand, a (secure) wireless link may be used to transfer security and access information from the mobile device to the Internet appliance. It may be verified that the mobile device is close to the Internet appliance as part of the authentication process (e.g. proximity detection or location detection within the mobile device). The Internet appliance may be a public access point allowing the user to transfer their files to a personal appliance (maybe the mobile device) over a fast and cheap connection. The access identifier may be stored in the protected area and (while it is still valid) can be retrieved on the mobile device. Bookmarks to frequently used locations within the protected area may be stored either in the protected area or on the mobile device.

Frequently-used and/or low-security document sets may be allowed to remain (encrypted) in the public space, rather than being deleted immediately after access by the Internet appliance, but the access identifier may made to change. The Internet appliance may also access the holding server over a secure connection such as a VPN.

The main differences between an embodiment of the present invention and the prior art systems described above, and the associated advantages of an embodiment of the present invention, will now be described.

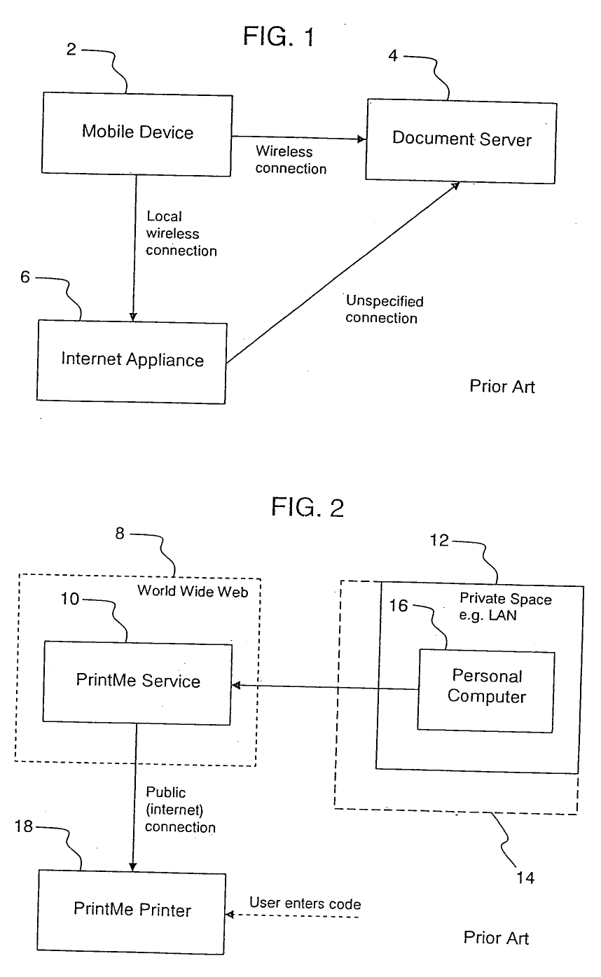

In the Satchel system described above with reference to FIG. 1, document tokens are stored on the mobile device. An embodiment of the present invention does not rely on the notion of a document token and the mobile device is not required to store any information about the documents. One embodiment of the present invention uses a URL to access a server, and then finds marked files on that server. Satchel uses URLs of the documents themselves.

In the Satchel system, document tokens are transferred wirelessly to the Internet appliance. In one embodiment of the present invention, a one-time access identifier is generated to represent the selected documents and this can be small enough that the user can type it in to the Internet appliance or other local device. The one-time nature of the access identifier in such an embodiment also ensures that it is safe for the user to type this information without fear of an onlooker gaining access to the information. By contrast, in the Satchel system the document tokens do not expire as soon as they are used.

Furthermore, the Satchel system does not address the problem of firewalls; a gateway machine is built that could tunnel back inside the firewall provided a special hole was configured in the firewall. This introduces an added security risk. One embodiment of the present invention solves the firewall problem by using existing technology to allow the mobile device, or other information device, access and to push the selected documents outside of the firewall for collection by the Internet or other appliance. This solution avoids the possibility of forming new holes in the firewall and thereby minimises the security risks associated with document transfer.

In view of the above, a system and method embodying the present invention has a security advantage over the Satchel system and also requires less custom support for the information device and the local device.

In the PrintMe system described above with reference to FIG. 2, there is no information device and no protected area within a remote server. The PrintMe system does not allow a mobile device with limited access to the protected area to upload a document for printing. An embodiment of the present invention allows the user to access and print a document stored on their private network after they have left the office. The mDoc product from Xerox® (see http://www.xerox.com/mdoc) can integrate mobile document access with the PrintMe system, but only enables the PrintMe scenario where the document is sent immediately to a specified printer; the user selects a document and specifies the identifier for the printer on the mobile device. With an embodiment of the present invention, the user can select documents for printing at one point in time (e.g. while on the train), but actually print the documents later when standing in front of the printer; indeed it is an important security feature in one embodiment of the present invention that the user is in the vicinity of the chosen printer when the selected documents are printed. There is also a further technical advantage where the service is to be carried out on a charged basis in that the supplier of the service controls the entire chain and can therefore issue any charges through the user's mobile phone operator; this may require the user entering information, perhaps automatically, into the printer identifying his mobile phone account so that when the documents are printed a charge can be made to the correct account.

In the PrintMe system, documents are sent to a public web service that is not controlled by the company to which the documents belong; in one embodiment of the present invention it is possible for a single entity to retain control over the protected and holding areas. In addition, one embodiment of the present invention enables a document to be encrypted from the time that it leaves the remote server until it arrives at the local device, so that the document never crosses a public network or is stored on a publicly-accessible server in an unencrypted state. An embodiment of the present invention also allows documents to flow in the other direction, so that where the local device is an input device such as a scanner, it is possible to transfer documents from the local device to the remote server; such an embodiment is described below.

In the PrintMe system, the printer must be specially enabled for the PrintMe service, rather than being a generic device with Internet browsing capabilities. An embodiment of the present invention enables the use of a generic Internet device, for example an Internet-enabled printer or any other device with a web browser (such as a computer or a PDA), as the local device. This allows for a much wider choice of devices for the mobile worker and greatly reduces the device-specific know-how required to maintain the system.

An embodiment of the present invention can also prevent the unwanted practice of sending unsolicited data (“spam”) to the printer. For example, in both the PrintMe and Xerox® Mdoc scenarios, malicious individuals are able to send documents (e.g. marketing information) to a remote printer even though they are not standing in front of it (similar to the already-common practice of sending unsolicited faxes). Even in the case where the user sends a document to the printer, but must select it or enter some authentication to release the document from the queue, the printer queue could get filled up with unsolicited data (an effective “denial of service” attack).

In U.S. Pat. No. 2002/0004404 described above the user sends the location of the required information to the appliance, and the appliance then retrieves this information. However, U.S. Pat. No. 2002/0004404 is concerned with an entirely different problem, simply displaying or printing information that is already in the public domain. In an embodiment of the present invention, a URL is not sent via a mobile phone network, as is the case in U.S. Pat. No. 2002/0004404.

Although the first embodiment has been described above as relating to the transfer of data items from a remote server to a local device, for example for output at the local device where the device is an output device, it is also possible to use an embodiment of the present invention for the secure transferral of data items from the local device to the remote server, for example where the local device is an input device such as a scanner.

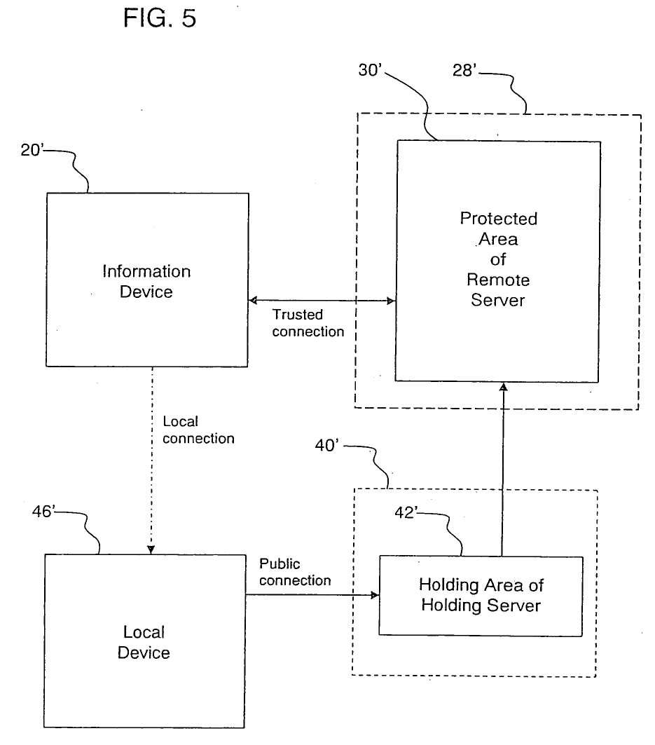

FIG. 5 is a block diagram illustrating a remote transferral system according to a second embodiment of the present invention. The remote transferral system comprises an information device 20′, a remote server 28′, a holding server 40′ and a local device 46′. The remote server comprises a protected area 30′. The holding server 40′ comprises a holding area 42′. Similarly-numbered parts of FIGS. 3 and 5 represent parts that operate in a similar way, and it will be appreciated by the person skilled in the art how to modify the system described above with reference to FIG. 3 so as to operate in accordance with the second embodiment shown in FIG. 5. Much of the description relating to the first embodiment applies equally to the second embodiment.

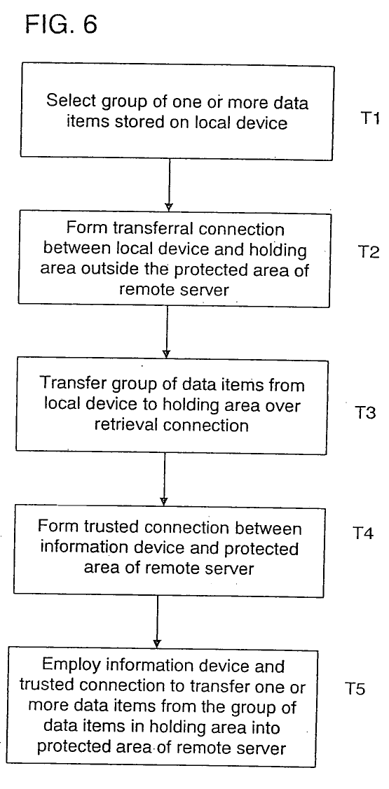

A method of transferring one or more data items from the local device 46′ to the protected area 30′ of the remote server 28′ will now be described with reference to the flowchart shown in FIG. 6. A group of one or more data items stored on the local device 46′ is selected (step T1). These data items may have been generated by the local device 46′ itself, for example after scanning documents. The act of selection may be by way of producing the data item in the first place; for example, a document that is scanned could be automatically selected for transferral to the remote server as part of the group, with no further manual selection by the user being required. A transferral connection is then formed between the local device 46′ and a holding area 42′ outside the protected area 30′ of the remote server 28′ (step T2). The group of data items is transferred from the local device 46′ to the holding area 42′ over the transferral connection (step T3). A trusted connection is formed between the information device 20′ and the protected area 30′ of the remote server 28′ (step T4). The information device 20′ and the trusted connection are employed to initiate the transfer of one or more data items from the group of data items in the holding area 42′ into the protected area 30′ of the remote server 28′ (step T5), at the request of the remote server 28′. In a similar way as the first embodiment, an access identifier containing location identification information may be input (either manually or electronically) into the local device 46′ to identify the location of the holding area 42′ so as to enable the transferral connection to be formed and the data item(s) to be pushed from the local device 46′ to the holding area 42′ over that connection. As in the first embodiment, the access identifier may be used to provide authentication and encryption information to the local device 46′ to enable successful interaction with the holding area 42′. Group identification information may be transferred from the local device 46′ to the information device 20′ to enable access to and selection of the appropriate data items transferred to the holding area 42′.

Such a method of the second embodiment can provide the mobile worker with a secure mechanism for transferring data items (e.g. scanned documents) from a local device (e.g. a public scanner) to the protected area of their remote server (e.g. a corporate LAN).

An embodiment of the present invention may find an application in many areas, such as in remote access situations, security, public appliances, automatic vending and printing.

Operation of various aspects of the methods described above can be controlled by an operating program on the information device, the remote server, the holding server and the local appliance, either locally on those parts or distributed between them. Such an operating program or programs may be stored on a computer-readable medium, or could, for example, be embodied in a signal such as a downloadable data signal provided from an Internet website. The appended claims are to be interpreted as covering an operating program by itself, or as a record on a carrier, or as a signal, or in any other form.

1. A method of retrieving one or more data items stored in a protected area of a remote server for transferral to a local device, comprising the steps of:
forming a trusted connection between an information device and the protected area of the remote server;
employing the information device and the trusted connection to select a first group of one or more data items stored in the protected area of the remote server;
transferring the first group of data items from the protected area to a holding area outside the protected area of the remote server;
forming a retrieval connection between the local device and the holding area;
determining a second group of one or more data items from the first group of data items transferred to the holding area; and
transferring the second group of data items from the holding area to the local device over the retrieval connection.

2. A method as claimed in claim 1, wherein the retrieval connection is formed in dependence upon a location identifier representing the location of the holding area.

3. A method as claimed in claim 2, wherein the location identifier itself contains sufficient information to identify the location of the holding area.

4. A method as claimed in claim 2, further comprising the step of looking up the location of the holding area in dependence upon the location identifier.

5. A method as claimed in claim 1, wherein the second group of data items is determined in dependence upon a group identifier identifying the first group of data items transferred to the holding area.

6. A method as claimed in claim 1, wherein access from the local device to the first group of data items transferred to the holding area is gained in dependence upon an access identifier associated with the first group of data items.

7. A method as claimed in claim 6, wherein the second group of data items is determined in dependence upon a group identifier identifying the first group of data items transferred to the holding area, and wherein the access identifier comprises the group identifier.

8. A method as claimed in claim 6, wherein the retrieval connection is formed in dependence upon a location identifier representing the location of the holding area, and wherein the access identifier comprises the location identifier.

9. A method as claimed in claim 6, wherein the access identifier is communicated to the local device from the information device.

10. A method as claimed in claim 9, wherein the access identifier is generated at the remote server and communicated to the information device over the trusted connection.

11. A method as claimed in claim 10, wherein the access identifier is stored on the remote server for subsequent retrieval by the information device.

12. A method as claimed in claim 9, wherein the access identifier is communicated to the local device by manually entering the access identifier into the local device.

13. A method as claimed in claim 9, further comprising the steps of making a connection between the information device and the local device, and communicating the access identifier from the information device to the local device over that connection.

14. A method as claimed in claim 13, wherein the connection between the information device and the local device is a wireless connection such as a Bluetooth or infrared connection.

15. A method as claimed in claim 13, wherein the connection between the information device and the local device is a physical connection.

16. A method as claimed in claim 15, further comprising the step of placing the information device in a cradle connected to the local device to form the physical connection.

17. A method as claimed in claim 13, wherein the connection between the information device and the local device is a secure connection.

18. A method as claimed in claim 1, wherein the second group of data items is determined to be the same as the first group of data items.

19. A method as claimed in claim 1, further comprising the step of employing the local device to select and determine the data items in the second group of data items.

20. A method as claimed in claim 19, comprising the steps of presenting a list of data items in the first group at the local device and selecting the second group from the list for transfer from the holding area to the local device.

21. A method as claim in claim 19, further comprising the steps of retrieving from the holding area information concerning one or more of the data items in the first group and presenting that information at the local device to facilitate the selection the second group of data items.

22. A method as claimed in claim 1, wherein the local device uses generic Internet browsing capabilities when accessing and/or selecting and/or retrieving data items in the holding area.

23. A method as claimed in claim 1, wherein at least one of the retrieval and trusted connections is a secure connection.

24. A method as claimed in claim 1, wherein the trusted connection is granted to the information device following verification by the remote server that the information device is authorised for access to the protected area.

25. A method as claimed in claim 1, wherein the protected area of the remote server is protected by a firewall.

26. A method as claimed in claim 1, further comprising the step of processing a data item before transferring it to the local device.

27. A method as claimed in claim 26, wherein the processing that is performed is dependent upon the type and/or location of the local device.

28. A method as claimed in claim 1, further comprising the step of storing the first group of data items in a hidden area within the holding area.

29. A method as claimed in claim 1, further comprising the step of storing the group of data items in a secure area of the holding area accessible only with appropriate authentication information.

30. A method as claimed in claim 29, wherein the secure area is password protected and the authentication information comprises a password.

31. A method as claimed in claim 1, further comprising the steps of encrypting a data item before transferring it to the holding area, and decrypting the data item after receipt at the local device.

32. A method as claimed in claim 31, wherein access from the local device to the first group of data items transferred to the holding area is gained in dependence upon an access identifier associated with the first group of data items, and wherein the access identifier comprises decryption information necessary to perform decryption of the data item.

33. A method as claimed in claim 1, wherein access from the local device to the first group of data items transferred to the holding area is gained in dependence upon an access identifier associated with the first group of data items, and further comprising the step of the revoking the access identifier after a predetermined number of uses, such as after one use.

34. A method as claimed in claim 33, further comprising the step of generating a new access identifier following revocation of the previous one.

35. A method as claimed in claim 1, wherein access from the local device to the first group of data items transferred to the holding area is gained in dependence upon an access identifier associated with the first group of data items, and further comprising the step of revoking the access identifier according to one or both of the following criteria: (a) after a predetermined length of time; and (b) after all the data items associated with the access identifier have been retrieved from the holding area.

36. A method as claimed in claim 1, further comprising the step of deleting a data item from the holding area after it has been retrieved a predetermined number of times, such as after one retrieval.

37. A method as claimed in claim 1, wherein access from the local device to the first group of data items transferred to the holding area is gained in dependence upon an access identifier associated with the first group of data items, and wherein one or more data items associated with the access identifier is/are deleted if the access identifier is revoked.

38. A method as claimed in claim 1, further comprising the step of deleting a data item from the public space after a predetermined length of time.

39. A method as claimed in claim 1, wherein the local device comprises an output device.

40. A method as claimed in claim 39, wherein the local device comprises a printer, and further comprising the step of printing part or all of at least one of the data items transferred to the local device on the printer.

41. A method as claimed in claim 39, wherein the local device comprises a display, and further comprising the step of displaying part or all of at least one of the data items transferred to the local device on the display.

42. A method as claimed in claim 1, wherein the information device forms part of the local device.

43. A method as claimed in claim 1, wherein the information device is a mobile phone.

44. A method as claimed claim 43, further comprising the step of authenticating the information device by requesting the Subscriber Identity Module number or other operator identifier from the information device.

45. A method as claimed in claim 1, wherein the holding area is located on the remote server.

46. A method as claimed in claim 1, wherein the holding area is located on a public server accessible by any public device.

47. A method as claimed in claim 1, wherein the local device is a public appliance accessible by the general public.

48. A method as claimed in claim 1, wherein the information device is in proximity to the local device.

49. A method as claimed in claim 48, further comprising the step of verifying that the information device is in proximity to the local device by comparing the location of the information device with the location of the local device.

50. A method as claimed in claim 1, further comprising the step of transferring one or more data items received at the local device to a separate device.

51. A method as claimed in claim 50, wherein the separate device is the information device.

52. A method as claimed in claim 50, wherein the local device is used as an access point for high-speed retrieval of data items to the separate device.

53. A method as claimed in claim 1, wherein the item or items in the first group of data items is/are pushed from the protected area into the holding area.

54. A method as claimed in claim 53, wherein the communication link between the protected area and the holding area is a one-way communication link so that the remote server can initiate communication with the holding area, but the holding area cannot initiate communication with the remote server.

55. A method as claimed in claim 53, wherein the communication link between the protected area and the holding area is a secure communication link.

56. A remote retrieval system comprising:
a remote server having a protected area for storing data items;
a holding area outside the protected area of the remote server;
an information device in communication with the protected area of the remote server over a trusted connection, the information device and the trusted connection being employed to select a first group of one or more data items stored in the protected area of the remote server, and the first group of data items being transferred from the protected area to the holding area outside the protected area of the remote server; and
a local device in communication with the holding area over a retrieval connection, a second group of one or more data items being determined from the first group of data items transferred to the holding area, and the second group being transferred from the holding area to the local device over the retrieval connection.

57. A method of employing an information device to retrieve one or more data items stored in a protected area of a remote server for transferral to a local device, comprising the steps of:
forming a trusted connection between the information device and the protected area of the remote server;
employing the information device and the trusted connection to select one or more data items stored in the protected area of the remote server;
causing the selected data items to be transferred from the protected area to a holding area outside the protected area of the remote server for subsequent retrieval by the local device.

58. An information device for retrieving one or more data items stored in a protected area of a remote server for transferral to a local device, comprising:
connection means for forming a trusted connection between the information device and the protected area of the remote server;
selection means for employing the information device and the trusted connection to select one or more data items stored in the protected area of the remote server; and
transferral means for causing the selected data items to be transferred from the protected area to a holding area outside the protected area of the remote server for subsequent retrieval by the local device.

59. An operating program which, when loaded into an information device, causes the device to become one as claimed in claim 58.

60. An operating program which, when run on an information device, causes the device to carry out a method as claimed in claim 57.

61. An operating program as claimed in claim 59, carried on a carrier medium.

62. An operating program as claimed in claim 60, carried on a carrier medium.

63. An operating program as claimed in claim 61, wherein the carrier medium is a transmission medium.

64. An operating program as claimed in claim 62, wherein the carrier medium is a transmission medium.

65. An operating program as claimed in claim 61, wherein the carrier medium is a storage medium.

66. An operating program as claimed in claim 62, wherein the carrier medium is a storage medium.

67. A method of transferring one or more data items from a local device to a protected area of a remote server, comprising the steps of:
selecting a group of one or more data items stored on the local device;
forming a transferral connection between the local device and a holding area outside the protected area of the remote server;
transferring the group of data items from the local device to the holding area over the transferral connection;
forming a trusted connection between an information device and the protected area of the remote server; and
employing the information device and the trusted connection to transfer one or more data items from the group of data items in the holding area into the protected area of the remote server.

68. A method as claimed in claim 67, wherein the one or more data items is/are pulled by the remote server into the protected area from the holding area.

69. A method as claimed in claim 67, wherein the local device comprises an input device.

70. A method as claimed in claim 69, wherein the local device comprises a scanner.

71. A method as claimed in claim 69, wherein the local device comprises a photocopier.

72. A remote transferral system comprising:
a remote server having a protected area for storing data items;
a holding area outside the protected area of the remote server;
a local device in communication with the holding area over a transferral connection, a group of one or more data items on the local device being transferred to the holding area over the transferral connection;
an information device in communication with the protected area of the remote server over a trusted connection, the information device and the trusted connection being employed to transfer one or more data items from the group of data items in the holding area into the protected area of the remote server.
